(19) United States
(12) Patent Application Publication
(10) Pub. No.: US 2024/0429793 A1
(43) Pub. Date: Dec. 26, 2024

(54) RECYCLING OF SYNCHRONOUS RELUCTANCE MOTORS

(71) Applicant: ABB Schweiz AG, Baden (CH)

(72) Inventors: Elio Perigo, Raleigh, NC (US); Darren Tremelling, Raleigh, NC (US); Sheng Zhong, Raleigh, NC (US); Matt Hoffman, Raleigh, NC (US)

(21) Appl. No.: 18/341,508

(22) Filed: Jun. 26, 2023

(51) Int. Cl. H02K 15/00; H02K 15/03

(52) U.S. Cl. CPC H02K 15/0006; H02K 15/03

(57) ABSTRACT

A system and method for separating permanent magnets from a rotor for repurposing. The method includes obtaining a first rotor including a plurality of permanent magnets located in a plurality of cavities arranged in the first rotor, heating the first rotor to a first temperature, removing the permanent magnets from a respective cavity by applying a force onto the permanent magnets at the first temperature, and repurposing the permanent magnets for a secondary use. The first temperature may be greater than a glass transition temperature and less than a melting temperature. The permanent magnets may be further processed for installation into a second rotor, the processing may include grinding the one or more permanent magnets to enable installation into the second rotor, analyzing a structural integrity of the permanent magnets to determine suitability for repurposing, and may also include separating the polymer material from a magnetic material.

### FIELD

The present disclosure relates to the field of permanent-magnet-based motors. More particularly, to recycling of permanent magnets from synchronous reluctance motors.

### BACKGROUND

Permanent magnet assisted synchronous reluctance machines typically include a rotor that utilizes hard magnetic materials to enhance their power factor and torque capability. The rotor can therefore include discrete permanent magnets located in slots arranged in the rotor. The permanent magnets may be sintered magnets or inserted via injection molding. A typical synchronous AC motor reaches its designed end-of-life after a defined period of time-which can be a function of application/market segment. The period of time can range between 5 to 20 years.

### SUMMARY

In some embodiments, a method includes obtaining a first rotor including a plurality of permanent magnets located in a plurality of cavities arranged in the first rotor, the first rotor being separated from a first AC motor, heating the first rotor to a first temperature, removing one or more permanent magnets from a respective cavity of the plurality of cavities by applying a force onto the one or more permanent magnets at the first temperature, and maintaining the removed one or more permanent magnets in a condition that is conducive for reuse.

In some embodiments, the method further includes processing the one or more permanent magnets for installation into a second rotor for a second AC motor. In some embodiments, processing the one or more permanent magnets further includes grinding the one or more permanent magnets to enable installation of the one or more permanent magnets into the second rotor.

In some embodiments, the method further includes analyzing a structural integrity of the one or more permanent magnets to determine a suitability for repurposing the one or more permanent magnets.

In some embodiments, the first rotor further includes one or more layers. In some embodiments, each layer of the one or more layers further includes the plurality of cavities, the plurality of cavities of each respective layer being in substantially colinear alignment with other layers of the one or more layers.

In some embodiments, the one or more permanent magnets includes polymer bonded permanent magnets, and the first temperature is greater than a softening temperature of a polymer material of the polymer bonded permanent magnets.

In some embodiments, the first temperature is greater than a glass transition temperature of the polymer material, and the first temperature is less than a melting temperature of the polymer material.

In some embodiments, the method further includes separating the polymer material from a magnetic material of the one or more permanent magnets.

In some embodiments, the method further includes heating the one or more permanent magnets to a second temperature, and the second temperature is greater than the first temperature.

In some embodiments, the force applied to the one or more permanent magnets includes gravity.

In some embodiments, the method further includes applying a mechanical force onto the one or more permanent magnets to force each of the one or more permanent magnets out of the respective cavity.

In some embodiments, the mechanical force includes at least one of a centrifugal force, a compressed air, and a ram. In some embodiments, the mechanical force acts on the one or more permanent magnets at a first side of the first rotor and the one or more permanent magnets is removed from a second side of the first rotor.

In some embodiments, the one or more permanent magnets includes sintered permanent magnets. In some embodiments, the first temperature is greater than a softening temperature of an adhesive retaining the sintered permanent magnets in the respective cavity.

In some embodiments, a system includes a heater, wherein the heater is configured to heat a first rotor to a first temperature, the first rotor includes a plurality of permanent magnets located in a plurality of cavities, and a collector, wherein the collector is configured to remove one or more permanent magnets from a respective cavity of the plurality of cavities by applying a force onto the one or more permanent magnets.

In some embodiments, the one or more permanent magnets include polymer bonded permanent magnets. In some embodiments, the first temperature is greater than a softening temperature of a polymer material of the polymer bonded permanent magnets.

In some embodiments, the first temperature is between a glass transition temperature and a polymer melting temperature.

In some embodiments, the system further includes a separator, the separator being configured to separate a polymer material from a magnetic material of the one or more permanent magnets.

In some embodiments, the separator is further configured to separate the polymer material from the magnetic material by heating the one or more permanent magnets to a second temperature greater than the first temperature.

In some embodiments, the first rotor includes one or more layers, and the plurality of cavities are disposed at each layer of the one or more layers, the plurality of cavities being in colinear alignment with the plurality of cavities at other layers of the one or more layers.

In some embodiments, the collector separates the one or more permanent magnets from the first rotor by application of a mechanical force onto the one or more permanent magnets.

In some embodiments, the mechanical force includes at least one of a centrifugal force, compressed air, and a ram, and the mechanical force acts on the one or more permanent magnets at a first side of the first rotor and the one or more permanent magnets is removed from a second side of the first rotor.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting of a synchronous reluctance motor, according to some embodiments.

FIG. 2 depicts a non-limiting example of a system, according to some embodiments.

FIG. 3 depicts a second non-limiting example of the system, according to some embodiments.

FIG. 4 depicts a flow diagram for a method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

AC motors are typically recycled by shredding the AC motor, or portions thereof, into a plurality of smaller pieces and separating the desired material (e.g., magnetic material) from the other rotor materials (e.g., rotor body). For example, an electromagnetic field is applied to the shredded materials and the magnetic materials are separated from the other rotor materials. Additional processing steps may be applied to the magnetic materials to further extract the desired raw materials from the undesired materials (e.g., plastics). For example, the materials can be heated to burn off any remaining impurities.

The various embodiments described herein are directed to improvements for recovery/separation of magnetic materials from a rotor body for repurposing the magnetic materials into a new rotor body. The various embodiments include systems, methods, and processes for recovery/separation of hard magnetic materials from soft magnetic materials. In this regard, the methods described herein relate to separation of permanent magnets from a rotor. The permanent magnets are located in respective cavities arranged in the rotor. In some embodiments, the rotor may include one or more layers, each layer including the plurality of cavities arranged at each respective layer to form the one or more poles of the rotor body. Accordingly, in some embodiments, each layer may be arranged respective to the other layers of the rotor such that the plurality of cavities at each layer are in colinear alignment respective to the other plurality of cavities arranged on the other layers of the rotor body. In some embodiments, each layer of the one or more layers may be in a predefined arrangement based on a desired operational characteristic of the AC motor.

The various embodiments described herein provide an improved process for separating permanent magnets from a rotor and maintaining the separated or removed permanent magnets in a condition that is conducive for reuse, such as to enable the permanent magnets to be repurposed into a second rotor. In some embodiments, the second rotor may be a new rotor for installation into a synchronous PM motor. Accordingly, the present embodiments are directed to a system for removing permanent magnets from a rotor stack (rotor body) without having to shred the rotor stack into smaller pieces and separating the hard and soft magnetic materials. Additionally, the various embodiments described herein result in a pre-formed permanent magnet that requires fewer processing steps to be used for a secondary use, such as being repurposed into a new rotor stack for installation into a new AC motor.

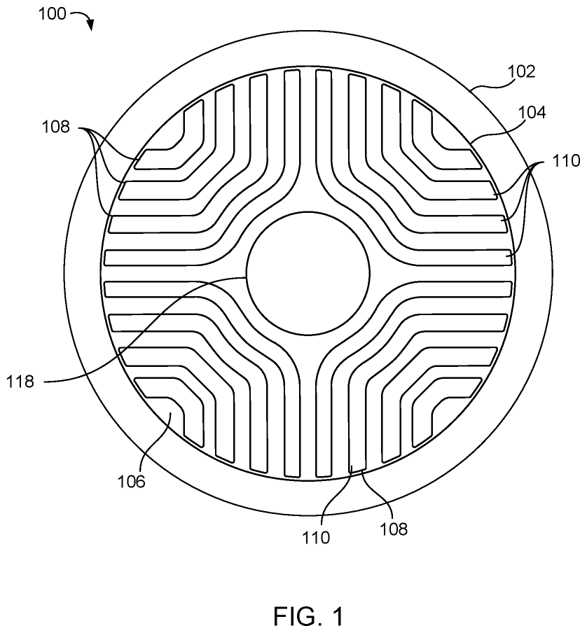

FIG. 1 depicts a non-limiting example of a synchronous reluctance motor 100, according to some embodiments. The synchronous reluctance motor 100 includes a stator 102 and a rotor 104. The stator 102 defines an interior space. The rotor 104 is disposed in the interior space of the stator 102. The rotor 104 includes a body 106 defining a structure. The rotor 104 also includes a plurality of cavities 108 arranged across the rotor 104, e.g., across a cross-section of the rotor, that are defined by the body 106. The rotor 104 has a plurality of permanent magnets 110 located in the cavities 108.

The permanent magnets 110 located in the cavities 108 of the rotor 104 form one or more poles. For example, the arrangement of permanent magnet 110 in the respective cavity 108 may form four poles at the rotor 104. In some embodiments, each cavity 108 may include a permanent magnet 110 located therein. In some embodiments, each cavity 108 in the body 106 may include at least one permanent magnet 110. In other embodiments, a respective cavity 108 may include two or more permanent magnets 110 located therein. For example, the respective cavity 108 may include three permanent magnets 110 located therein. In other embodiments, not every cavity 108 may include a permanent magnet 110 located therein. Accordingly, in some embodiments, some of the cavities 108 may not include permanent magnets 110 located therein. It is to be appreciated by those having ordinary skill in the art that the number of poles of the rotor 104 is not intended to be limiting and the rotor 104 can include any even number of poles in accordance with this disclosure. It is also to be appreciated by those having ordinary skill in the art that the number of permanent magnet 110 located in each respective cavity 108 is not intended to be limiting and may include one or more magnets in accordance with the present disclosure.

The body 106 of the rotor 104 may be formed of any of a plurality of materials. In some embodiments, the body 106 of the rotor 104 (e.g., rotor stack) may be composed of soft magnetic materials. In some embodiments, the body 106 of the rotor 104 may be composed of one or more soft magnetic materials. In other embodiments, the body 106 of the rotor 104 may be composed of sintered powdered metal. In some embodiments, the body 106 or the rotor 104 may be composed of magnetic steel. It is to be appreciated by those having ordinary skill in the art that the materials of the body 106 of the rotor 104, e.g., rotor stack, is not intended to be limiting and may include any of a plurality of materials in accordance with this disclosure.

Additionally, the permanent magnets 110 may be formed of a hard magnetic material (e.g., hard magnets). In some embodiments, the permanent magnet 110 may be formed from one or more hard magnetic materials. In some embodiments, the permanent magnet 110 may be composed of NdFeB (“neodymium”). In some embodiments, the permanent magnet 110 may be a polymer bonded neodymium magnet. In other embodiments, the plurality of permanent magnets 110 may be a sintered permanent magnet. In some embodiments, each of the permanent magnet 110 of the plurality of permanent magnets 110 may be composed of alnico, alcomax, ferrites, cobalt platinum, rare earth cobalt, neodymium, other materials, or any combinations thereof.

As used herein, “soft magnetic material” refers to those materials that are easily magnetized and demagnetized. Typically, such materials have an intrinsic coercivity of less than 1000 Am⁻¹. An example of soft magnetic material includes non-grain-oriented steel. However, soft magnetic materials are not limited to non-grain-oriented steel and may include other materials in accordance with this disclosure.

Additionally, as used herein, “hard magnetic material” refers to those materials, such as permanent magnets, that retain their magnetism after being magnetized. Typically, such materials have an intrinsic coercivity of greater than approximately 10 kAm⁻¹. Examples of hard magnetic materials include alnico, alcomax, ferrites, cobalt platinum, rare earth cobalt, neodymium, other materials, or any combinations thereof.

As used herein, “polymer bonded magnets” are composites with permanent magnet powder, such as ferrite or NdFeB embedded in a polymer binder matrix. In this regard, polymer bonded magnets having NdFeB embedded therein are referred to as polymer bonded neodymium magnets.

The permanent magnets 110 are disposed in the respective cavities 108 of the rotor 104. In some embodiments, the permanent magnets 110 may be a sintered magnet. In other embodiments, the permanent magnets 110 may be a polymer injected permanent magnet. In some embodiments, the rotor 104 may include one or more sintered magnets and one or more polymer injected permanent magnets. Accordingly, the rotor 104 may include sintered magnets, a polymer injected permanent magnets, or both located therein in the cavities 108.

In some embodiments, the rotor 104 may include one or more layers 120 that are arranged in a stacked configuration to form the body 106 of the rotor 104, e.g., rotor stack. Each layer 120 may include the plurality of cavities 108 formed therein arranged across the respective layer 120. In this regard, each layer 120 may include the plurality of cavities 108 arranged across the layer 120. In some embodiments, the cavities 108 may be formed at one side of the layer 120. In other embodiments, the cavities 108 may extend through the respective layer 120 from one side and through the layer 120 to the opposite side. Additionally, each of the layers 120 may be aligned respective the other layers 120 of the rotor 104 such that the plurality of cavities 108 may form channels that extend through the body 106, such as to enable the permanent magnets 110 installed into the rotor 104 to extend through the channel and the layers 120. In some embodiments, the one or more layers 120 may be arranged in the rotor 104 such that the plurality of cavities 108 are in colinear alignment through the rotor 104. In other embodiments, the one or more layers 120 may be arranged in the rotor 104 such that the plurality of cavities 108 at each layer are substantially aligned relative to an adjacent layer. In other embodiments, the arrangement of the plurality of cavities 108 at each layer may be based on a desired performance characteristics of the synchronous reluctance motor 100. In this regard, it is to be appreciated that the location of the plurality of cavities 108 at each respective layer of the one or more layers 120 are not intended to be limiting and each respective layer of the one or more layers 120 may or may not be in alignment respective of the other layers of the rotor 104 in accordance with this disclosure.

In the illustrated embodiment, the cavities 108 in the rotor 104 are boat-shaped. However, the shape, size, and dimensions of the cavities 108 in the rotor 104 is not intended to be limiting. In some embodiments, the cavities 108 may be circular. In other embodiments, the cavities 108 may be elongated with rounded ends. It is to be appreciated by those having ordinary skill in the art that the shape, size, and/or dimensions of the cavities 108 are not intended to be limiting and each respective cavity 108 can include any of a plurality of shapes, sizes, and/or dimensions in accordance with this disclosure.

The body 106 also defines a shaft opening 118 of the synchronous reluctance motor 100. Accordingly, the synchronous reluctance motor 100 may include a motor shaft (not shown) that extends through the shaft opening 118 and the rotor 104 is configured to rotate in response to an electromagnetic field applied to the rotor 104.

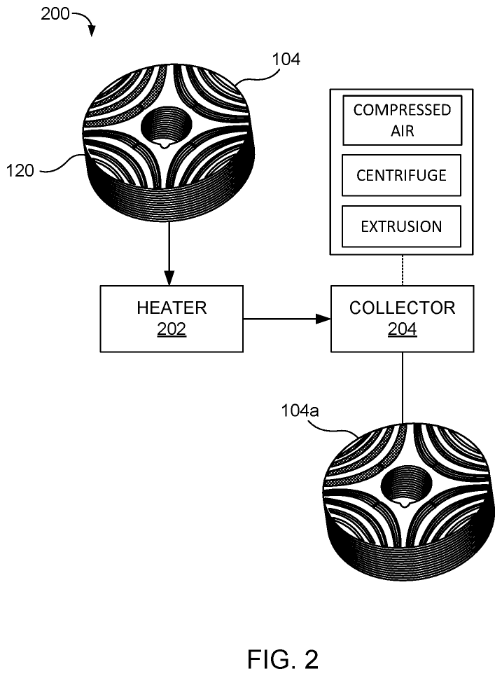

FIG. 2 depicts a non-limiting example of a system 200, according to some embodiments.

From the synchronous reluctance motor 100, such as that shown in FIG. 1, the system 200 obtains the rotor 104 for removal/separation of the permanent magnets 110 from the rotor 104. The removal/separation of the permanent magnets 110 from the rotor 104 is performed by the system 200 such that each of the permanent magnets 110 extracted by the system 200 may be processed to determine the suitability for repurposing (e.g., reusing) the permanent magnet 110 for installation into a new rotor such as rotor 104a. In some embodiments, the motor shaft located in the shaft opening 118 may also be removed from the rotor 104 prior to removal/separation of the plurality of permanent magnets 110 from the rotor 104 by the system 200.

The system 200 includes a heater 202. The heater 202 produces heat that is applied to the rotor 104 to bring the rotor 104 to a desired temperature or within a temperature range. The temperature to which the rotor 104 is heated may be dependent on the materials that form the permanent magnets 110. In some embodiments, the rotor 104 may be heated to a specific temperature. In other embodiments, the rotor 104 may be heated to within a specific temperature range.

Preferably, the heater 202 includes an inductive heating coil. The inductive heating coil can decrease the time required to heat the rotor 104 to enable separation of the permanent magnet 110 from the rotor 104. Accordingly, the inductive heating coil increases the throughput for processing rotors, such as rotor 104, for removal/separation of the permanent magnets 110 from the rotor 104. In some embodiments, the heater 202 may be a furnace. The furnace may use gas and/or resistive heating elements to raise the temperature of the rotor 104 to the desired temperature. It is to be appreciated by those having ordinary skill in the art that the type of heater 202 is not intended to be limiting and may include any of a plurality of heating devices in accordance with this disclosure.

In some embodiments, the heater 202 may heat the rotor 104 and the permanent magnets 110 located therein to a certain temperature based on the materials of the permanent magnets 110. In some embodiments, the permanent magnets 110 in the rotor 104 may be polymer bonded permanent magnets and the heater 202 may heat the rotor 104 and the polymer bonded permanent magnets located therein to a softening temperature of the polymer matrix. In some embodiments, such as for amorphous polymers, the softening temperature is typically above the glass transition temperature of the polymer material. In other embodiments, such as for semi-crystalline polymers, the softening temperature may be greater than the glass transition temperature and less than a melting temperature of the polymer material. Once the polymer bonded magnetic composite softens in response to the heating, the permanent magnets 110 can be removed from the rotor 104, and the respective cavity 108, by applying a force onto the permanent magnet 110. In this regard, by applying the force onto the permanent magnet 110, the permanent magnet 110 is evacuated from the rotor 104 and the respective cavity 108. In some embodiments, the force may be applied onto the permanent magnet 110 at one side of the rotor 104 at the respective cavity 108 and the permanent magnet 110 may be evacuated from the opposite side of the rotor 104. In this regard, the permanent magnet 110 may then be collected for reuse, in accordance with the present disclosure.

In some embodiments, the permanent magnets 110 in the rotor 104 may be an injection molded permanent magnet. In a non-limiting example, in some embodiments, the injection molded permanent magnet may include one or more polymer materials and having a softening temperature as provided in Table 1 below:

TABLE 1
Processing temperatures for selected polymer matrix.

| | Softening |
|---|---|
| Polymer | Temperature (° C.) |
| Polyvinyl chloride (PVC) | 100~260 |
| Acrylonitrile butadiene styrene (ABS) | 105~200 |
| Polycarbonate (PC) | 150~200 |
| PA6 (Nylon) | 60~285 |
| PA12 (Nylon) | 140~350 |
| Polyethylene terephthalate (PET) | 80~264 |
| Polypropylene (PP) | 100~180 |
| Polyethylene (PE) | 80~141 |

Table 1 includes polymer materials used in the preparation of polymer bonded permanent magnets and their corresponding softening temperatures. As shown in Table 1, the respective softening temperatures corresponding to each polymer material include a temperature range, the lower temperature being a glass transition temperature and the upper temperature being a melting temperature of the polymer material. In this regard, when heat is applied to the permanent magnets 110 by the heater 202, the rotor 104 and the permanent magnets 110 are heated to a temperature within the limits of the softening temperatures associated with the corresponding polymer material to limit causing material degradation of the permanent magnets 110, which renders them unsuitable for repurposing into rotor 104a without additional processing steps to extract the magnetic materials from the polymer matrix. The permanent magnets 110 are heated to a temperature within the limits of the softening temperatures, such as those shown in Table 1, such that the permanent magnets 110 may be extracted from the rotor 104 while avoiding material degradation of the permanent magnets 110 such that the permanent magnets 110 may be suitable for a secondary use, such as to be repurposed into the rotor 104a. It is to be appreciated by those having ordinary skill in the art that Table 1 is exemplary and the polymer materials suitable for use in the permanent magnet 110 and the corresponding softening temperatures are not intended to be limiting. Accordingly, it is also to be appreciated by those having ordinary skill in the art that a permanent magnet may include one or more of the polymer materials as provided in Table 1, other polymer materials not shown in Table 1, or any combinations thereof, in accordance with the present disclosure.

In some embodiments, the heater 202 may heat the rotor 104 and the permanent magnets 110 located therein to a temperature, hereinafter referred to as a first temperature. The permanent magnets 110 is heated to the first temperature based on the type of polymer material in the permanent magnets 110, such as according to the softening temperatures in accordance with Table 1. The rotor 104 is heated to the first temperature to enable the softening of the hard magnetic composite of the permanent magnets 110 for extraction of the permanent magnets 110 from the respective cavity 108 of the rotor 104. Additionally, the upper limit of the softening temperature is to prevent chemical degradation of the polymer matrix as a result of the polymer material being exposed to too high a temperature. Accordingly, in some embodiments, the permanent magnets 110 extracted in this matter, and within the temperature range between the glass transition temperature and the melting temperature of the polymer material, may be directly repurposed into a new rotor, such as rotor 104a, that is configured to be installed into an AC motor without having to perform the additional processing steps of separating the polymer material from the filler magnetic material so long as the polymer matrix has not chemically degraded.

In some embodiments, the rotor 104 may include sintered permanent magnets that are installed into and affixed to the respective cavity 108 of the rotor 104 using an adhesive material. In this regard, the temperature to which the heater 202 may heat the rotor 104 and the sintered permanent magnet is dependent on the softening temperature of the adhesive material that affixes the permanent magnets 110 to the respective cavity 108. Once the adhesive material retaining the sintered permanent magnet in the respective cavity 108 sufficiently softens in response to the heating, the sintered permanent magnet may either fall out of the respective cavity 108 of the rotor 104 or a force may be applied to the permanent magnet 110 to extract the permanent magnet 110 from the respective cavity 108. In some embodiments, the permanent magnet 110 may fall out of the respective cavity 108 as a result of the adhesive qualities of the adhesive material degrading in response to the heat and the limited contact area between the sintered permanent magnet and the surfaces of the respective cavity 108. In other embodiments, the permanent magnet 110 may be pushed out of respective cavity 108 of the rotor 104 by applying a force onto the permanent magnet 110 at one side of the rotor 104 to enable the permanent magnet 110 to be evacuated from the other side of the rotor 104 at the respective cavity 108. The permanent magnet 110 can then be collected and repurposed for installation into rotor 104a, in accordance with the present disclosure.

In some embodiments, the permanent magnet 110 may be a sintered permanent magnet affixed in the respective cavity 108 by an adhesive material. In some embodiments, the adhesive material retaining the permanent magnet 110 in the respective cavity 108 may be one of the adhesive materials provided in Table 2 below:

TABLE 2
Processing temperatures for selected adhesives.

| | Softening |
|---|---|
| Adhesive | Temperature (° C.) |
| EP17HT-LO (one part epoxy) | 316 |
| EP42HT-2 (two part epoxy) | 232 |
| EP45HTAN (two part epoxy) | 260 |
| MasterSil 800 (one part silicone) | 300 |
| MasterSil 972TC-LO (two part silicone) | 204 |
| MB600SCN (sodium silicate) | 371 |

The adhesives included in Table 2 may be used in the installation of sintered permanent magnets into the respective cavity 108 of a rotor 104. It is to be appreciated by those having ordinary skill in the art the adhesive materials provided in Table 2 and the corresponding softening temperatures is exemplary and is not intended to be limiting. Accordingly, it is to be appreciated by those having ordinary skill in the art that the permanent magnet 110 may be affixed to the respective cavity 108 in the rotor 104 by any of a plurality of adhesives, such as those adhesives provided in Table 2, other adhesive materials not shown in Table 2, or any combinations thereof, in accordance with the present disclosure.

In some embodiments, the heater 202 may heat the adhesive material when heating the rotor 104 to the temperature (e.g., first temperature) corresponding to the particular adhesive material, such as in accordance with Table 2, to enable the adhesive material to soften and to enable extraction of the permanent magnet 110 from the respective cavity 108 of the rotor 104. Accordingly, in some embodiments, such permanent magnet 110 extracted in this matter may be directly repurposed into a new rotor, such as rotor 104a, that is configured to be installed into an AC motor so long as the dimensions of the permanent magnet 110 are appropriate for the respective cavity 108 in the rotor 104a.

The system includes a collector 204. The collector 204 applies a force onto the permanent magnets 110 to extract the permanent magnets 110 from the respective cavity 108 of the rotor 104. Once the rotor 104 and the permanent magnet 110 (and the adhesive) is heated to the first temperature, the permanent magnet 110 located in the respective cavity 108 of the rotor 104 is extracted from the rotor 104. In some embodiments, the permanent magnets 110 located in the rotor 104 may be separated from the rotor 104 in one stage (e.g., one heating cycle). In other embodiments, the permanent magnets 110 may be separated from the rotor 104 in more than one stage (e.g., successive heating and extraction cycles) to enable the removal of the permanent magnets 110 from the particular rotor 104. In some embodiments, the permanent magnets 110 may be removed from the rotor 104 in more than one stage to avoid deformation of the permanent magnet 110 during the removal process.

The collector 204 provides for the removal of the permanent magnets 110 from the rotor 104 by application of a force onto the plurality of permanent magnets 110. In some embodiments, the collector 204 provides for the removal of the permanent magnets 110 from the rotor 104 through gravity. For example, the rotor 104 may be suspended such that a bottom of the rotor 104, and the cavities 108, is unsupported and the force of gravity enables each permanent magnet 110 from the respective cavity 108 to fall out. In another example, the permanent magnet 110 may be a sintered permanent magnet and the sintered permanent magnet may fall out from a bottom of the rotor 104 and the respective cavity 108 by gravity as a result of the adhesive material no longer presenting relevant fixation performance as a result of the heating and the permanent magnet 110 having a relatively small contact area with the corresponding interior surface of the respective cavity 108.

Additionally, the collector 204 may cause the removal of the plurality of permanent magnets 110 from the rotor 104 by application of a mechanical force onto the permanent magnet 110 at one side of the rotor 104 to push the permanent magnet 110 out the respective cavity 108 at the other side of the rotor 104. In some embodiments, the mechanical force may include application of compressed air onto the permanent magnet 110 at one side of the rotor 104, thereby resulting in the evacuation of the permanent magnet 110 from the other side of the rotor 104 and out the opening to the respective cavity 108.

In some embodiments, the mechanical force may include application of a centrifugal force onto the rotor 104, e.g., rotating the rotor 104 around a relative axis, thereby resulting in the forced removal of the permanent magnet 110 from the side of the rotor 104 opposite the relative axis and out the respective cavity 108.

In other embodiments, the mechanical force may include extrusion of the permanent magnet 110 from the respective cavity 108. In this regard, an elongate member, such as a ram extruder, may be applied to the permanent magnet 110 at one side of the rotor 104 in the respective cavity 108 and the elongate member may push the permanent magnet 110 out the other side of the rotor 104 and the respective cavity 108. In this regard, the elongate member is capable of withstanding the high temperature (e.g., the first temperature) of the rotor 104 and the permanent magnets 110 as applied by the heater 202. In some embodiments, the collector 204 may include an actuator that moves the elongate member relative to the rotor 104 such that the elongate member extends into the respective cavity 108 and forces the permanent magnet 110 out of the respective cavity 108 of the rotor 104. In some embodiments, the elongate member may be a cylindrically shaped elongate member. In other embodiments, the shape and dimensions of the elongate member may correspond to the shape and dimensions of the respective cavity 108 such that the elongate member substantially corresponds to the shape of the opening of the respective cavity 108 to enable the extraction of the permanent magnets 110. Additionally, in some embodiments, the collector 204 may include one or more elongate members arranged on a base member such that the one or more elongate members may be simultaneously applied to one side of the rotor 104 at the plurality of cavities 108 to simultaneously extend through the plurality of cavities 108 and to force out the plurality of permanent magnets 110 in the respective cavity 108 out the opposite side of the rotor 104.

In some embodiments, the collector 204 may include a plurality of elongate members for forcing the plurality of permanent magnets 110 from the plurality of cavities 108. In this regard, each of the plurality of elongate members may be defined by a shape having dimensions complementary to a shape of the opening of the respective cavity 108 of the plurality of cavities 108 in the rotor 104 to enable the plurality of elongate members to simultaneously extend through the plurality of cavities 108 at the rotor 104 to provide for an efficient extraction of the plurality of permanent magnets 110 in a single stage without having to perform multiple heating stages to extract the plurality of permanent magnets 110 from the rotor 104. In some embodiments, the heater 202 and the collector 204 may be combined into one device that simultaneously heats the rotor 104 and forces the plurality of permanent magnets 110 from the plurality of cavities 108, in accordance with the present disclosure.

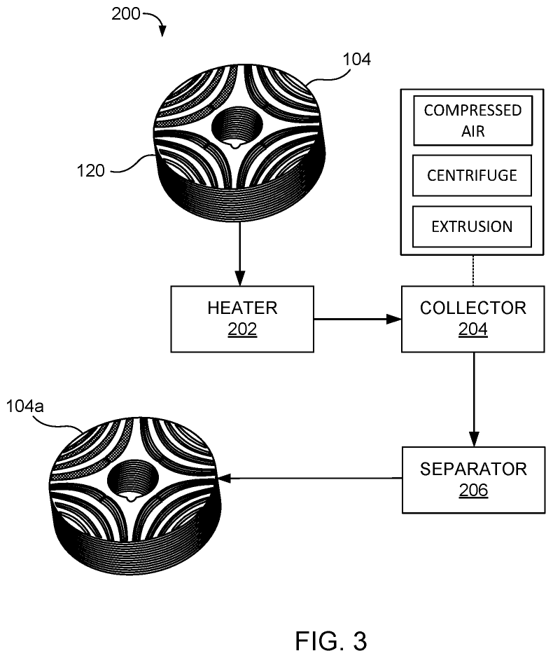

FIG. 3 depicts a second non-limiting example of the system 200, according to some embodiments.

In some embodiments, heating the permanent magnet 110 to the first temperature may cause chemical degradation of the permanent magnet 110. In this regard, each permanent magnet 110 extracted from the rotor 104 may be analyzed to determine whether degradation has occurred at the permanent magnet 110. In some embodiments, heating the permanent magnet 110 to the first temperature may cause chemical degradation of the polymer material of the permanent magnet 110. In other embodiments, heating the permanent magnet 110 to the first temperature may cause degradation of the sintered material of the permanent magnet 110.

Accordingly, as shown in FIG. 3, the system 200 may include a separator 210. The separator 210 separates the hard magnetic materials from the other materials such that the hard magnetic materials may be used as feedstock for reforming a new permanent magnet 110. In this regard, for any permanent magnet 110 showing evidence of degradation, the separator 210 separates the hard magnetic materials from the other materials of the permanent magnet 110. For example, the neodymium magnetic material may be separated from the polymeric matrix. In some embodiments, the other materials may include polymers, fillers, binders, adhesives, soft magnetic materials, other materials, or any combinations thereof.

In some embodiments, the separator 210 may include one or more components configured to shred the permanent magnet 110 removed from the rotor 104 into a plurality of smaller pieces to facilitate separating the hard magnetic materials from the other materials. The hard magnetic materials may then be separated from the other materials to enable the hard magnetic materials to be used as feedstock. In some embodiments, separating the polymer material from the permanent magnet 110 includes dissolving the polymer material using an organic solvent. Accordingly, the separated hard magnetic materials may be converted to feedstock for using the hard magnetic materials in a newly formed permanent magnet, such as permanent magnet 110.

In some embodiments, the separator 210 may also include a heating element which heats the permanent magnet 110 to melt away the other materials from the hard magnetic materials. In some embodiments, the separator 210 may heat the plurality of smaller pieces resulting from shredding the permanent magnet 110 to melt the other materials away from the hard magnetic materials. For example, the separator 210 may heat the polymer material to a temperature (e.g., second temperature) exceeding the melting temperature of the polymer material, such as provided in Table 1, to burn off the polymer material from the hard magnetic materials.

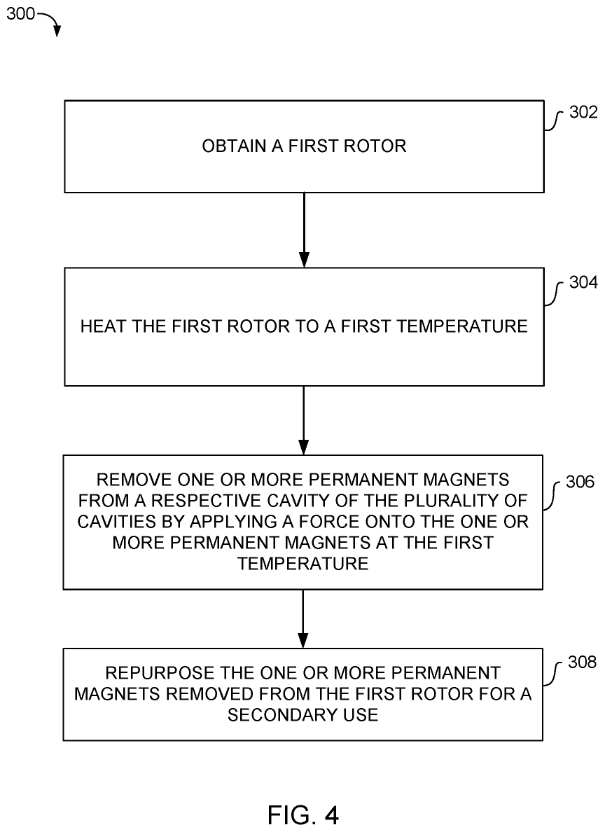

FIG. 4 depicts a flow diagram for a method 300, according to some embodiments.

At 302, the method 300 includes obtaining a rotor 104. The rotor 104 includes a plurality of permanent magnets 110 located in a plurality of cavities 108 arranged in the rotor 104. In some embodiments, each permanent magnet 110 of the plurality of permanent magnets 110 is located in a respective cavity 108 of the plurality of cavities 108. In this regard, in some embodiments, each respective cavity 108 may include a single permanent magnet 110. In other embodiments, each respective cavity 108 may include one or more of the permanent magnet 110. For example, a respective cavity 108 of the plurality of cavities 108 may include two of the permanent magnets 110 located therein. Additionally, in some embodiments, obtaining the rotor 104 includes separating the rotor 104 from the synchronous reluctance motor 100. In some embodiments, the rotor 104 is also separated from a motor shaft located in the shaft opening 118 of the rotor 104.

At 304, the method 300 includes heating a rotor 104 to a certain temperature. In some embodiments, the rotor 104 may be heated to a first temperature. In some embodiments, the permanent magnet 110 may be a polymer bonded permanent magnet and the first temperature may be greater than a softening temperature of a polymer material of the permanent magnet 110. In some embodiments, the first temperature may be greater than a glass transition temperature of the polymer material of the permanent magnet 110 and less than a melting temperature of the polymer material of the permanent magnet 110. In other embodiments, the permanent magnet 110 may be a sintered permanent magnet and the first temperature may be greater than a melting temperature of the adhesive that affixes the permanent magnet 110 into the respective cavity 108 of the rotor 104.

In some embodiments, the rotor 104 may include one or more layers 120 joined together to form a rotor stack. In this regard, each layer of the one or more layers 120 may include the plurality of cavities 108 arranged on the layer. In some embodiments, each respective cavity 108 of the plurality of cavities 108 at the respective layer may include a permanent magnet 110 located therein. In other embodiments, the layers may be arranged such that the plurality of cavities 108 are in colinear alignment to form a plurality of channels, where each channel extends from one side of the rotor 104 to the opposite side of the rotor 104 and each channel includes a permanent magnet 110 located therein.

At 306, the method 300 includes removing one or more of the permanent magnet 110 of the plurality of permanent magnets 110 from a respective cavity 108 of the plurality of cavities 108 by applying a force onto the one or more of the permanent magnet 110 when the rotor 104 and the one or more of the permanent magnet 110 is at the first temperature. In some embodiments, the force applied to the one or more of the permanent magnet 110 in the rotor 104 is a gravitational force. In this regard, in some embodiments, the heat applied to the rotor 104 softens the one or more of the permanent magnet 110 and/or the adhesive affixing the permanent magnet 110 in the respective cavity 108 such that the permanent magnet 110 falls out of the respective cavity 108 in response to the gravitational force overcoming the forces retaining the permanent magnet 110 in the respective cavity 108.

In some embodiments, the method 300 further includes applying a mechanical force onto the one or more of the permanent magnet 110 at one side of the rotor 104 to force each of the one or more of the permanent magnet 110 out the other side of the rotor 104 from the respective cavity 108 of the plurality of cavities 108. The mechanical force comprises at least one of centrifugal force, compressed air, an extruder (e.g., a ram). In some embodiments, the mechanical force may be a centrifugal force. In other embodiments, the mechanical force may be compressed air. In other embodiments, the mechanical force may be an extruder, such as a ram extruder.

At 308, the method 300 includes maintaining the removed one or more permanent magnets 110 in a condition that is conducive for reuse. In some embodiments, secondary uses, e.g., reuse, for the permanent magnets 110 include, for example, installing the permanent magnet 110 into a second rotor, such as rotor 104a as shown in FIG. 2. In some embodiments, the method 300 further includes repurposing the one or more permanent magnets 110 removed from the first rotor 104 for a secondary use. However, it is to be appreciated by those having ordinary skill in the art that the term “secondary use,” is not intended to be limiting and refers to reusing a product or component in a new application after its original application or purpose.

In some embodiments, the method 300 further includes processing the one or more of the permanent magnets 110 for reuse. In some embodiments, processing the one or more of the permanent magnets 110 includes installing the permanent magnets 110 into a second rotor for a second AC motor. In some embodiments, processing the one or more of the permanent magnet 110 further includes grinding the one or more of the permanent magnet 110 to enable the installation of the one or more of the permanent magnet 110 into the second rotor. In some embodiments, grinding the permanent magnet 110 prepares a surface of the permanent magnet 110 for installation into the second rotor. In other embodiments, the grinding performed on the permanent magnet 110 reshapes the permanent magnet 110 to enable the permanent magnet 110 to be installed into a second rotor.

Additionally, in some embodiments, the method 300 further includes analyzing a structural integrity of the one or more of the permanent magnet 110 to determine a suitability for repurposing the one or more of the permanent magnet 110 for installation into the second rotor. In this regard, heating the rotor 104 and the one or more of the permanent magnet 110 to the first temperature may cause chemical degradation of the polymer material or the sintered body of the permanent magnet 110. The structural integrity of the one or more of the permanent magnet 110 is analyzed after removal of the one or more of the permanent magnet 110 to enable determining the suitability of repurposing each of the one or more of the permanent magnet 110 into a second rotor.

For instances where analysis of the permanent magnet 110 detects chemical degradation of the polymer material, the polymer material may be separated from the magnetic materials of the permanent magnet 110. In this regard, in some embodiments, the method 300 further includes separating the polymer material from a magnetic material of the one or more of the permanent magnet 110. In some embodiments, separating the polymer material from the magnetic materials includes heating the one or more of the permanent magnet 110 to a second temperature. In some embodiments, the second temperature is greater than first temperature. In some embodiments, the second temperature exceeds a melting temperature of the polymer material such that the polymer material may be burned off from the hard magnetic materials. In other embodiments, separating the polymer material from the magnetic materials includes dissolving the polymer material using an organic solvent. In this regard, the separated magnetic materials, such as neodymium, may be collected and repurposed to from a new permanent magnet 110.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the terms “repurpose,” “reuse,” and “recycle” refers to returning a material to a previous stage in a cyclic process. For example, returning a magnet extracted from an end-of-life rotor and installing the extracted magnet into a rotor to be used again in another synchronous AC motor.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:

disposed directly between both of the two other structural elements such that the particular structural component is in direct contact with both of the two other structural elements;

disposed directly next to only one of the two other structural elements such that the particular structural component is in direct contact with only one of the two other structural elements;

disposed indirectly next to only one of the two other structural elements such that the particular structural component is not in direct contact with only one of the two other structural elements, and there is another element which juxtaposes the particular structural component and the one of the two other structural elements;

disposed indirectly between both of the two other structural elements such that the particular structural component is not in direct contact with both of the two other structural elements, and other features can be disposed therebetween; or any combination(s) thereof.

As used herein “embedded” means that a first material is distributed throughout a second material.

### ASPECTS

Various Aspects are described below. It is to be understood that any one or more of the features recited in the following Aspect(s) can be combined with any one or more other Aspect(s).

Aspect 1. A method comprising: obtaining a first rotor comprising a plurality of permanent magnets located in a plurality of cavities arranged in the first rotor, wherein the first rotor is separated from a first AC motor; heating the first rotor to a first temperature; removing one or more permanent magnets from a respective cavity of the plurality of cavities by applying a force onto the one or more permanent magnets at the first temperature; and maintaining the removed one or more permanent magnets in a condition that is conducive for reuse.

Aspect 2. The method according to aspect 1, further comprising: processing the one or more permanent magnets for installation into a second rotor for a second AC motor, wherein processing the one or more permanent magnets further comprises grinding the one or more permanent magnets to enable installation of the one or more permanent magnets into the second rotor.

Aspect 3. The method according to any of the preceding aspects, further comprising: analyzing a structural integrity of the one or more permanent magnets to determine a suitability for repurposing the one or more permanent magnets.

Aspect 4. The method according to any of the preceding aspects, wherein the first rotor further comprises: one or more layers, wherein each layer of the one or more layers further comprises the plurality of cavities, the plurality of cavities of each respective layer being in substantially colinear alignment with other layers of the one or more layers.

Aspect 5. The method according to any of the preceding aspects, wherein the one or more permanent magnets comprises polymer bonded permanent magnets, and wherein the first temperature is greater than a softening temperature of a polymer material of the polymer bonded permanent magnets.

Aspect 6. The method according to aspect 5, wherein the first temperature is greater than a glass transition temperature of the polymer material, wherein the first temperature is less than a melting temperature of the polymer material.

Aspect 7. The method according to aspects 5 or 6, further comprising: separating the polymer material from a magnetic material of the one or more permanent magnets.

Aspect 8. The method according to any of the preceding aspects, further comprising: heating the one or more permanent magnets to a second temperature, wherein the second temperature is greater than the first temperature.

Aspect 9. The method according to any of the preceding aspects, wherein the force applied to the one or more permanent magnets comprises gravity.

Aspect 10. The method according to any of the preceding aspects, further comprising: applying a mechanical force onto the one or more permanent magnets to force each of the one or more permanent magnets out of the respective cavity.

Aspect 11. The method according to aspect 10, wherein the mechanical force comprises at least one of: a centrifugal force, a compressed air, and a ram; wherein the mechanical force acts on the one or more permanent magnets at a first side of the first rotor and the one or more permanent magnets is removed from a second side of the first rotor.

Aspect 12. The method according to any of the preceding aspects, wherein the one or more permanent magnets comprises sintered permanent magnets, and wherein the first temperature is greater than a softening temperature of an adhesive retaining the sintered permanent magnets in the respective cavity.

Aspect 13. A system comprising: a heater, wherein the heater is configured to heat a first rotor to a first temperature, the first rotor comprising a plurality of permanent magnets located in a plurality of cavities; and a collector, wherein the collector is configured to remove one or more permanent magnets from a respective cavity of the plurality of cavities by applying a force onto the one or more permanent magnets.

Aspect 14. The system according to aspect 13, wherein the one or more permanent magnets comprise polymer bonded permanent magnets, and wherein the first temperature is greater than a softening temperature of a polymer material of the polymer bonded permanent magnets.

Aspect 15. The system according to aspects 13 or 14, wherein the first temperature is between a glass transition temperature and a polymer melting temperature.

Aspect 16. The system according to aspects 13, 14, or 15, further comprising: a separator, wherein the separator is configured to separate a polymer material from a magnetic material of the one or more permanent magnets.

Aspect 17. The system according to aspect 16, wherein the separator is further configured to separate the polymer material from the magnetic material by heating the one or more permanent magnets to a second temperature greater than the first temperature.

Aspect 18. The system according to aspects 13, 14, 15, 16, or 17, wherein the first rotor comprises: one or more layers, wherein the plurality of cavities are disposed at each layer of the one or more layers, the plurality of cavities being in colinear alignment with the plurality of cavities at other layers of the one or more layers.

Aspect 19. The system according to aspects 13, 14, 15, 16, 17, or 18, wherein the collector separates the one or more permanent magnets from the first rotor by application of a mechanical force onto the one or more permanent magnets.

Aspect 20. The system according to aspect 19, wherein the mechanical force comprises at least one of: a centrifugal force, compressed air, and a ram, wherein the mechanical force acts on the one or more permanent magnets at a first side of the first rotor and the one or more permanent magnets is removed from a second side of the first rotor.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A method comprising:
obtaining a first rotor comprising a plurality of permanent magnets located in a plurality of cavities arranged in the first rotor,
wherein the first rotor is separated from a first AC motor;
heating the first rotor to a first temperature;
removing one or more permanent magnets from a respective cavity of the plurality of cavities by applying a force onto the one or more permanent magnets at the first temperature; and
maintaining the removed one or more permanent magnets in a condition that is conducive for reuse.

2. The method of claim 1, further comprising:
processing the one or more permanent magnets for installation into a second rotor for a second AC motor,
wherein processing the one or more permanent magnets further comprises grinding the one or more permanent magnets to enable installation of the one or more permanent magnets into the second rotor.

3. The method of claim 1, further comprising:
analyzing a structural integrity of the one or more permanent magnets to determine a suitability for repurposing the one or more permanent magnets.

4. The method of claim 1, wherein the first rotor further comprises:
one or more layers,
wherein each layer of the one or more layers further comprises the plurality of cavities, the plurality of cavities of each respective layer being in substantially colinear alignment with other layers of the one or more layers.

5. The method of claim 1, wherein the one or more permanent magnets comprises polymer bonded permanent magnets, and
wherein the first temperature is greater than a softening temperature of a polymer material of the polymer bonded permanent magnets.

6. The method of claim 5, wherein the first temperature is greater than a glass transition temperature of the polymer material,
wherein the first temperature is less than a melting temperature of the polymer material.

7. The method of claim 5, further comprising:
separating the polymer material from a magnetic material of the one or more permanent magnets.

8. The method of claim 7, further comprising:
heating the one or more permanent magnets to a second temperature, wherein the second temperature is greater than the first temperature.

9. The method of claim 1, wherein the force applied to the one or more permanent magnets comprises gravity.

10. The method of claim 9, further comprising:
applying a mechanical force onto the one or more permanent magnets to force each of the one or more permanent magnets out of the respective cavity.

11. The method of claim 10, wherein the mechanical force comprises at least one of:
a centrifugal force,
a compressed air, and
a ram;
wherein the mechanical force acts on the one or more permanent magnets at a first side of the first rotor and the one or more permanent magnets is removed from a second side of the first rotor.

12. The method of claim 1, wherein the one or more permanent magnets comprises sintered permanent magnets, and
wherein the first temperature is greater than a softening temperature of an adhesive retaining the sintered permanent magnets in the respective cavity.

13. A system comprising:
a heater,
wherein the heater is configured to heat a first rotor to a first temperature, the first rotor comprising a plurality of permanent magnets located in a plurality of cavities; and
a collector,
wherein the collector is configured to remove one or more permanent magnets from a respective cavity of the plurality of cavities by applying a force onto the one or more permanent magnets.

14. The system of claim 13, wherein the one or more permanent magnets comprise polymer bonded permanent magnets, and
wherein the first temperature is greater than a softening temperature of a polymer material of the polymer bonded permanent magnets.

15. The system of claim 14, wherein the first temperature is between a glass transition temperature and a polymer melting temperature.

16. The system of claim 13, further comprising:
a separator,
wherein the separator is configured to separate a polymer material from a magnetic material of the one or more permanent magnets.

17. The system of claim 16, wherein the separator is further configured to separate the polymer material from the magnetic material by heating the one or more permanent magnets to a second temperature greater than the first temperature.

18. The system of claim 13, wherein the first rotor comprises:
one or more layers,
wherein the plurality of cavities are disposed at each layer of the one or more layers, the plurality of cavities being in colinear alignment with the plurality of cavities at other layers of the one or more layers.

19. The system of claim 13, wherein the collector separates the one or more permanent magnets from the first rotor by application of a mechanical force onto the one or more permanent magnets.

20. The system of claim 19, wherein the mechanical force comprises at least one of:
a centrifugal force,
compressed air, and
a ram,
wherein the mechanical force acts on the one or more permanent magnets at a first side of the first rotor and the one or more permanent magnets is removed from a second side of the first rotor.
